(19) United States
(12) Patent Application Publication
(10) Pub. No.: US 2006/0075477 A1
(43) Pub. Date: Apr. 6, 2006

(54) Electronic device communication methods, appliance verification methods, appliance programming methods, appliances, articles of manufacture, and client electronic devices

(76) Inventor: Rajesh K. Shenoy, San Jose, CA (US)

Correspondence Address: HEWLETT-PACKARD COMPANY;Intellectual Property Administration, P.O. Box 272400, Fort Collins, CO, 80527-2400, US

(21) Appl. No.: 10/957,312

(22) Filed: Sep. 30, 2004

(51) Int. Cl. G06K 9/00

(52) U.S. Cl. 726/7

(57) ABSTRACT

Electronic device communication methods, appliance verification methods, appliance programming methods, appliances, articles of manufacture, and client electronic devices are described. According to one embodiment, an electronic device communications method includes providing an appliance, deploying the appliance comprising associating the appliance with communications media, providing an identifier of the association of the appliance with the communications media, generating verification information using the identifier, communicating the verification information externally of the appliance, using the communicated verification information, verifying at least one aspect of the deployed appliance, and encrypting data communications intermediate a client and the appliance responsive to the verifying.

### FIELD OF THE DISCLOSURE

Aspects of the disclosure relate to electronic device communication methods, appliance verification methods, appliance programming methods, appliances, articles of manufacture, and client electronic devices.

### BACKGROUND OF THE DISCLOSURE

Over the past several years, there has been an increasing concern about the security of appliances such as disk drives, spoolers, printers, scanners and multi-functional peripherals. The concern is both around the privacy of the data being sent as well concern about whether one is interacting with the intended device or an imposter (i.e., is the printer address the one for the intended printer or a fraudulent address).

In the past, interception and “man in the middle” attacks were prevented by using 1-1 cables (such as centronix or universal serial bus). However, as appliances moved from being client peripherals to networked resources, the problem emerged of identifying the intended appliance and securing the communication to that appliance.

In the case of printers, a common approach (seen in many offices) has been to post a label of the printer name with its network address. In this manner, if an individual trusts the label, they could use that address to send a print job to the intended printer. Similar techniques are used for scanners, disk-drives, spoolers and other such appliances.

There are several problems with the label-based approach. The first is that many deployments use the dynamic host control protocol (DHCP) and thus the address of the appliance can change over time. This means that while a client might have once had the correct address, the appliance address may change and the client can easily have a mis-directed message. Similarly, an imposter might intentionally mislabel an appliance such as a printer to intercept print jobs in public venues such as coffee shops or airport lounges.

Some manufacturers provide a user interface on their appliance that will report the address of the appliance on a screen or (in the case of some printers) on a printout. This helps overcome the intentional/accidental mislabeling of a device, but does not address dynamic protocol update or re-configuration of the client devices.

In addition, the above techniques do not address privacy of the transmitted data and thus eaves-droppers can intercept sensitive documents/material.

Sensitive documents can be addressed through techniques such as the secure sockets layer (SSL). In this protocol, the client and server agree on a session key that is used to encode messages exchanged between the client and server.

Other methods include IP Security Protocol (IP-Sec) which replaces the Internet Protocol with a secured packet routing mechanism. IPSec ensures that a message will be delivered only to the destination address but doesn't secure the association of the target with the address (i.e., the mechanism of discovering the correct IP address for the appliance is not addressed by either IP-Sec or SSL).

An approach to certifying the destination has been to use a challenge in the initial message from the client to the target. The challenge is encrypted with a shared secret or other keying mechanism and only the rightful recipient should be able to answer the challenge and thereby affirm the identity. The issue here is one of key distribution. If the key is shared across a family of appliances, then the imposter can redirect the print job to a second printer and intercept the material. If the key is particular to a printer, then discovering that key is an issue and similar to discovering the printer's IP address noted above.

Thus there remains a need to discover the provenance of an appliance's address, and/or to communicate with that appliance in a secure manner. At least some aspects of this disclosure are related to improved apparatus and methods for implementing electronic communications between electronic devices such as an appliance and a client in one embodiment.

### SUMMARY

According to some aspects, electronic device communication methods, appliance verification methods, appliance programming methods, appliances, articles of manufacture, and client electronic devices are described.

According to one embodiment, an electronic device communications method comprises providing an appliance, deploying the appliance comprising associating the appliance with communications media, providing an identifier of the association of the appliance with the communications media, generating verification information using the identifier, communicating the verification information externally of the appliance, using the communicated verification information, verifying at least one aspect of the deployed appliance, and encrypting data communications intermediate a client and the appliance responsive to the verifying.

According to another embodiment, an appliance comprises a communications interface configured to implement communications with respect to communications media coupled with a client, and processing circuitry coupled with the communications interface and wherein the processing circuitry is configured to access an electronic address after the appliance is associated with the electronic address to implement communications with respect to the communications medium, to initiate generation of an identifier certificate using the electronic address, and to initiate communication of the identifier certificate externally of the appliance to enable verification of the electronic address of the appliance to implement communications via the communications medium intermediate the client and the appliance.

Other embodiments and aspects are described as is apparent from the following discussion.

### DESCRIPTION OF THE DRAWINGS

FIG. 1 is a functional block diagram of a communications system according to one embodiment.

FIG. 2 is a functional block diagram of an electronic device appliance according to one embodiment.

FIGS. 3A-3B are illustrative representations of verification information of an electronic device appliance according to exemplary embodiments.

FIG. 4 is a flow chart illustrating an exemplary method for generating verification information according to one embodiment.

FIG. 5 is a flow chart illustrating an exemplary method for using verification information to implement communications according to one embodiment.

FIG. 6 is a flow chart illustrating an exemplary method for performing verification of FIG. 5 according to one embodiment.

### DETAILED DESCRIPTION

According to some aspects of the disclosure, methods and apparatus are described for implementing communications of increased security intermediate plural devices such as an electronic device client and an electronic device appliance. At least some aspects allow the electronic devices to communicate without initially knowing an identifier (e.g., electronic address) of the other. As described further below, exemplary aspects provide initiation of a secure communications channel by an appliance instead of a client (e.g., communicating verification information by an appliance upon deployment of the appliance in a communications infrastructure). Some aspects described further below may be utilized to discourage a rogue device from spoofing as an original proper device including intercepting and replacing communicated information (thereby enabling reading of communications between the devices) or by replacing an identifier of a device with its own (thereby causing a denial of service attack). Other aspects or embodiments are possible and may be utilized to discourage other types of malicious activity. Additional embodiments and aspects are described in a co-pending U.S. patent application entitled “Communications Methods And Appliances,” listing Rajesh Krishna Shenoy and Keith E. Moore as inventors, having docket number 200407119-1, filed the same day as the present application and the teachings of which are incorporated herein by reference.

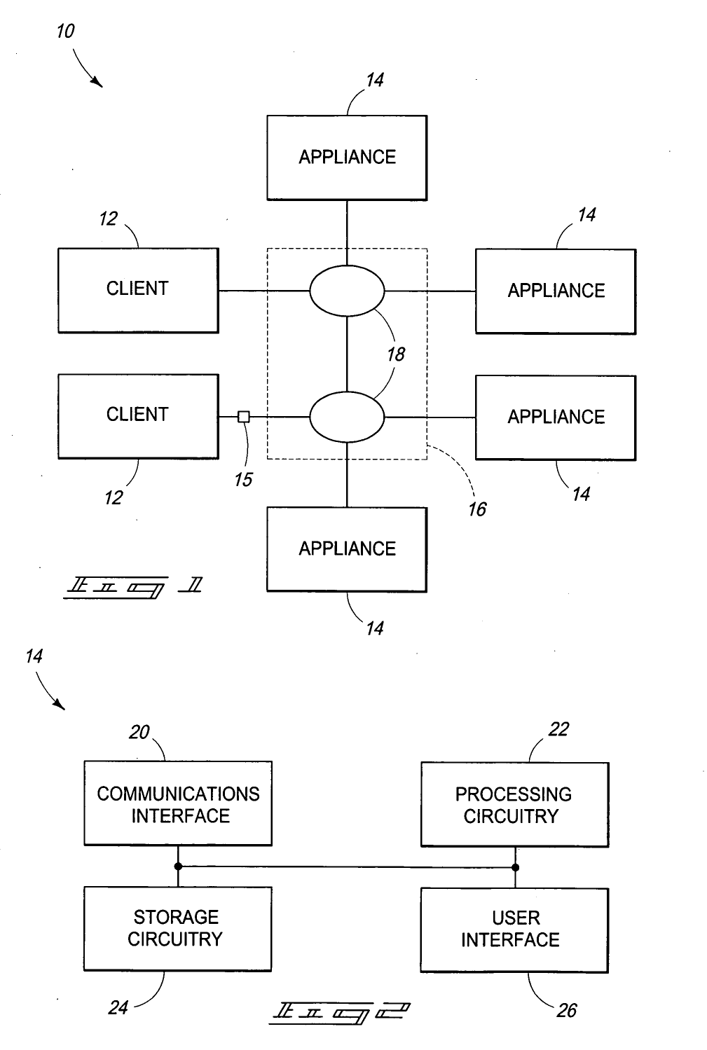

Referring to FIG. 1, an exemplary configuration of a communications system 10 is shown. Communications system 10 may include one or more electronic device clients (i.e., clients) 12, one or more electronic device appliances (i.e., appliances) 14, one or more intermediaries 15, and communications media 16. In one example, communications system 10 is embodied as a networked arrangement of clients 12 configured to use the resources of appliances 14. Exemplary clients 12 include personal computers, workstations, and other electronic devices configured to implement electronic communications with respect to appliances 14 or other devices. Exemplary appliances 14 may have resources which may be accessed and used by clients 12 and may be embodied as printers, multiple functions peripherals, facsimile machines, scanners, copiers, network routers, projectors, television sets, music equipment, cameras, electronic appliances, dish washers, washing machines, or other electronic devices. Exemplary intermediaries 15 may include firewall devices, print spoolers or other devices which may be associated with a respective client 12 and/or appliance 14 (e.g., intermediaries 15 may be associated with one or both of client 12 and/or appliance 14 attempting to establish a secure communications channel).

Communications media 16 includes a communications network in the illustrated embodiment. Exemplary communications networks include private and/or public networks and may implement packet-switched TCP/IP communications in one implementation. In more specific examples, communications networks include a zero-configuration network, UPnP based network or an IT-administrated network. The depicted network includes a plurality of nodes 18 such as switches, routers or other devices capable of receiving electronic communications and forwarding the electronic communications to appropriate recipients. Individual ones of clients 12 and appliances 14 and other electronic devices coupled with communications media 16 may be individually considered to be associated with communications media 16 and may have a respective unique communications identifier (e.g., electronic address) identifying the association and usable by communications media 16 and communicating devices to direct communications to appropriate recipients as well as identify a respective sending device of communications. Exemplary communications identifiers including electronic addresses may include internet protocol (IP) addresses, uniform resource locators (URLs), domain names, port numbers or other identification protocols. Other communications identifiers are possible.

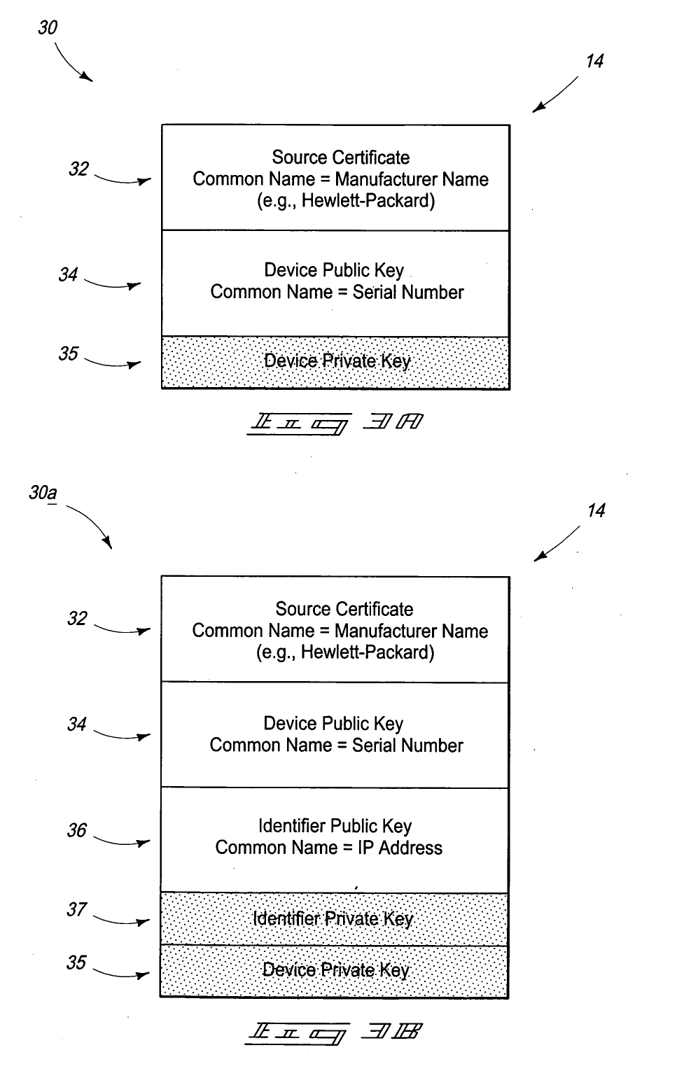

Referring to FIG. 2, an exemplary configuration of an appliance 14 is shown. The depicted appliance 14 includes a communications interface 20, processing circuitry 22, storage circuitry 24 and a user interface 26. Other circuitry or components may be provided in other embodiments and corresponding to the respective implementation or configuration of appliance 14 (e.g., appliance 14 may include a print engine in a printer configuration). In addition, individual clients 12 may be similarly configured as appliance 14 in one arrangement and may individually include a communications interface, processing circuitry, storage circuitry and a user interface as well as any additional components or circuitry applicable to the implementation of the client 12.

In one embodiment, the processing circuitry 22 may comprise circuitry configured to implement desired programming. For example, the processing circuitry may be implemented as a processor and/or other structure configured to execute executable instructions including, for example, software and/or firmware instructions. Other exemplary embodiments of processing circuitry include hardware logic, PGA, FPGA, ASIC, state machines, and/or other structures. These examples of processing circuitry 22 are for illustration and other configurations are possible. Processing circuitry 22 may formulate communications for external communication, process received communications, implement exemplary secure communication procedures described herein, and/or perform other operations to control operations of the respective device in one embodiment.

Storage circuitry 24 is configured to store electronic data and or programming such as executable instructions (e.g., software and/or firmware), data, or other digital information and may include processor-usable media. Processor-usable media includes any article of manufacture which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information. As described further below, storage circuitry 24 may be configured to store certificates, keys (e.g., public and private) and other desired information.

User interface 26 may include a display configured to depict information to a user as well as a keyboard or other input device configured to receive input from a user.

At least some aspects described herein are directed towards implementing communications of increased security intermediate plural devices such as clients 12 and appliances 14. In one embodiment, aspects are directed towards individual appliances 14 initiating secure communications channels with clients 12 without either of the client 12 or appliance 14 having knowledge of the communications identifier of the other device.

In one embodiment, a source of appliances 14 configures the respective appliances 14 before deployment to implement or establish a secure communications channel upon deployment of the device in the communications system 10. For example, deployment includes in one arrangement associating the appliances 14 with communications media 16. The association may include coupling the communications interface 20 to an appropriate network connection and assigning the appliance 14 an appropriate communications identifier such as an electronic address so communications from and to the appliance 14 may be identified and/or specified. Appliances 14 may be configured to include at least some verification information prior to deployment for use in implementing communications of increased security according to exemplary embodiments described herein.

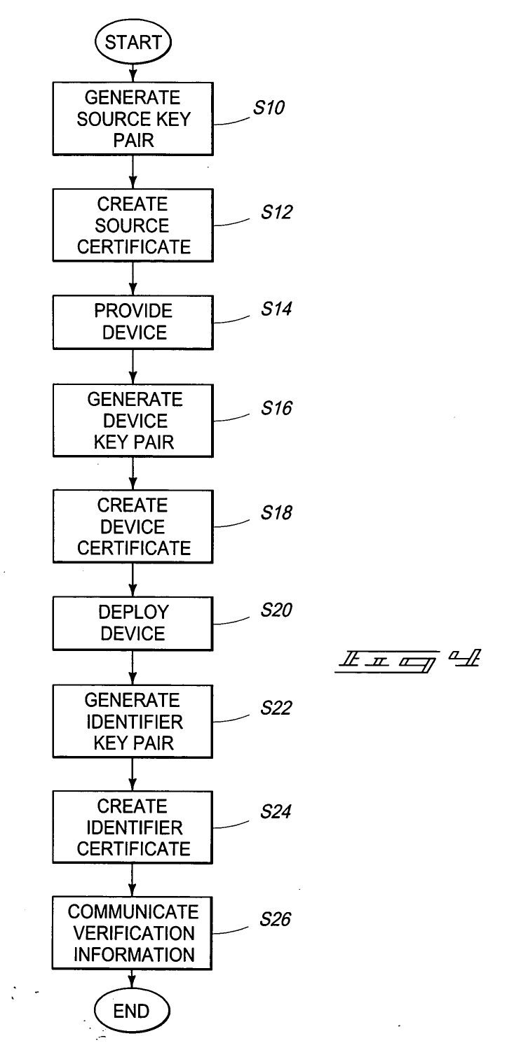

Referring to FIGS. 3A and 3B, exemplary verification information 30, 30a of an appliance 14 is illustrated prior to deployment (FIG. 3A) and following deployment (FIG. 3B), respectively. Verification information 30 provided before deployment may be referred to as predeployment verification information and verification information provided after deployment may be referred to as postdepolyment verification information 30a.

In one implementation, verification information 30 may be installed upon or otherwise provided to appliance 14 by an appropriate source of appliance 14 (e.g., manufacturer, or any other appropriate entity with access to appliance 14 prior to deployment). For example, in one embodiment, verification information 30 may be stored using storage circuitry 24.

Exemplary verification information 30 includes a source certificate 32, a device public key 34 and a device private key 35 in one embodiment and may be utilized to prevent a rogue device from presenting a certificate of appliance 14 as its own. Source certificate 32 may correspond to a source private and public key pair generated by a manufacturer (e.g., Hewlett-Packard Company) or other source of appliance 14 in one arrangement. In one embodiment, a root certificate authority (CA) (not shown) signs the generated source public key and the common name (e.g., manufacturer name) given by a manufacturer (e.g., Hewlett-Packard Company) or other source of appliance 14 or other entity to create the source certificate 32. The source certificate 32 may be utilized to verify that appliance 14 was provided by an authentic source. In other embodiments, the source may self-sign the public key to create source certificate 32.

Once fabricated or otherwise provided, appliance 14 may be assigned a unique device identifier, such as a device serial number, by the source or other entity. The unique device identifier may be used as a common name of a device certificate to be formed in one embodiment. The source or other appropriate entity may generate a device private and public key pair in one embodiment. The source may sign the device public key and the common name using the source private key creating a device certificate (not shown in FIG. 3A but may also be stored in appliance 14) usable to verify that the appliance is authentic in one embodiment. Further, appliance 14 may also include the device private key 35 enabling the appliance 14 to sign certificates in one implementation (e.g., after deployment). To that end, appliance 14 may be given certificate signing rights permitting the appliance to act as a certificate authority in the future. In another implementation, the appliance 14 may be configured to use an external certificate authority for future certificate generation (e.g., after deployment when the user or installer registers the device with the manufacturer, the other certificates may be provided by the source, root certificate authority or other certificate authority).

After deployment, appliance 14 may be associated with communications media 16 and have a communications identifier of the association of appliance 14 with communications media 16 (e.g., an electronic address as mentioned in the above-described example). Following provision of the communications identifier, appliance 14 may create a new public and private key pair which may be referred to as an identifier public key 36 and an identifier private key 37. In one example, appliance 14 creates a Certificate Signing Request (CSR) with the communications identifier as the common name. Using the CSR, appliance 14 issues an identifier certificate signed with the device private key 35. The identifier certificate may be utilized to verify that the communications identifier corresponds to appliance 14. In another embodiment, appliance 14 may communicate the CSR to an external certificate authority for generation of the identifier certificate 36 which is returned to appliance 14 for storage. Other embodiments are possible.

Accordingly, in one embodiment before deployment, appliances 14 supplied by a common source may have verification information 30 including a common source certificate 32 and different respective device certificates and different respective device private keys 35. In one embodiment after deployment, appliances 14 may have verification information 30a additionally including identifier public key 36, identifier private key 37 and an identifier certificate. The above described verification information 30, 30a is exemplary for one possible method of implementing a channel of communications having increased security. Other methods are possible including more or less verification information either before or after deployment.

Thereafter, following generation, the verification information 30a including the source certificate 32, device certificate 34, and identifier certificate 36 may be made available for searching by clients 12 and used to verify at least one aspect of appliance 14 for security purposes (e.g., the identifier private key 37 and the device private key 35 are not made available in at least some embodiments). In the examples of FIGS. 3A and 3B, the shaded boxes correspond to verification information which is retained internally of appliance 14 and not externally communicated.

In one communications example, a networking protocol wherein one message can be sent to multiple participants (e.g., clients 12) may be used (e.g., communications media 16 implementing a multicast channel). Clients 12 may listen on the multicast channel for the verification information 30a according to the presently described example. An administrator may be omitted in embodiments wherein the exemplary multicast channel is utilized.

Accordingly, in one embodiment, verification information 30, 30a may be communicated to communications media 16. Verification information 30a may be communicated in different methods or using different structures in different embodiments. As mentioned above, communications media 16 may comprise a multicast channel. Communications media 16 may be implemented using primary and secondary communication channels in one embodiment. The primary communications channel may communicate data intermediate clients 12 and appliances 14 while the verification information 30a may be communicated using the secondary communications channel (e.g., multicast channel). The utilization of the secondary communications channel may reduce traffic on the primary communications channel of communications media 16. In one embodiment, the secondary communications channel may be implemented as a wireless channel (e.g., 802.11b). Usage of a 802.11x channel in at least one embodiment discourages rogue devices from receiving the verification information 30a. In one embodiment, a menu button on user interface 26 of appliance 14 may be depressed indicating verification information 30a is being or will be communicated for a predetermined period of time. Thereafter, a menu button on client 12 or other desired device may be depressed indicating the time to listen for the verification information 30a. A relatively small time interval would reduce the likelihood that a rogue party could intercept a self-signed certificate and replace it with another. In another embodiment, communications interfaces 20 of client 12 and appliance 14 may be configured with infrared, Bluetooth, USB, flash, or other appropriate interface circuitry to communicate verification information 30a in relatively close physical proximity. In yet another embodiment, communications data and verification information are communicated using the same communications channel.

A client 12 may search for a particular service (e.g., printing service) upon communications media 16. In response, the client 12 may be presented with verification information 30a from a plurality of appliances 14 able to assist with the desired services. In one embodiment, the client 12 may process the received verification information 30a for security purposes to verify one or more aspect of the appliance(s) 14. In other embodiments, a device external of client 12 may perform the verification operations and communicate the verification results to client 12.

In a more specific example, the client 12 may confirm that an appliance 14 is from a valid source, the appliance 14 is authentic and/or the identifier of the association of the appliance 14 with the communications media 16 corresponds to the identifier of the appliance 14 the client 12 is currently communicating with. For example, exemplary communications identifiers may include electronic addresses in one embodiment and the client 12 may confirm that the electronic address of the verification information 30a matches the electronic address being communicated with by the client 12. Client 12 may compare the extracted communications identifier with the electronic address from which the verification information 30a was received in one embodiment.

In one exemplary verification embodiment, the validity or authenticity of the source and appliance 14 and its communications identifier may be established by verifying one or more certificate of the verification information 30a with or without user intervention. If a plurality of certificates are included within the verification information 30a, then the chain of certificates may be verified in one implementation as described further below. As mentioned above, client 12 may be configured similarly to the exemplary embodiment of appliance 14 shown in FIG. 2. Accessing and processing of verification information 30a by client 12 may be implemented by appropriate processing circuitry of client 12 in one embodiment. If appropriate, the processing circuitry of client 12 may implement encrypted data communications with the appropriate appliance 14 following processing of the verification information 30a.

In one possible verification method, client 12 may obtain the identifier certificate and may extract the communications identifier (e.g., electronic address) therefrom. Further, the client 12 may identify the signing entity which signed the identifier certificate. For example, the respective appliance 14 may sign the identifier certificate in an embodiment. Accordingly, in such an arrangement, client 12 may then access the device certificate 34 to identify the signing entity of device certificate 34. In the above-described exemplary embodiment, the source of appliance 14 is identified as the entity which signed the device certificate 34. Thereafter, the client 12 may then access the source certificate 32 to identify the signing entity of the source certificate 32. In the above-described exemplary embodiment, the root certificate authority is identified as the signing entity. Client 12 may reject the verification information 30a if client 12 does not recognize the root certificate authority or if the root certificate authority is on a certification revocation list in one embodiment.

In one embodiment, following verification of appliance 14 itself, client 12 may verify that the verification information 30a was issued to an appliance 14 communicating at the respective correct communications identifier (e.g., that the communications identifier of the appliance 14 communicating the verification information 30a corresponds to the communications identifier of the common name of the identifier certificate in the verification information 30a). The exemplary embodiment achieves discovery of the communications identifier of appliance 14 as well as the establishment of keys for communications intermediate client 12 and appliance 14. This verification may be useful to prevent attacks wherein a rogue device redirects traffic to itself and presents its own certificate to a receiving device.

Verification information 30a may vary in other embodiments including additional or less verification information regarding communications intermediate client 12 and appliance 14. For example, in one embodiment, it may be desired to only secure the communications identifier of appliance 14. Accordingly, more or less aspects of appliance 14 may be verified in other embodiments and corresponding to the contents of verification information 30a. Also, timing information may be specified by an appliance 14 which indicates when a key of the appliance 14 becomes invalid. If communications are not desired by the client 12 with respect to appliance 14 at a moment in time, the communications identifier for the appliance 14 may be stored but not the key in one embodiment. The communications identifier for the appliance 14 could be reused and a new public key obtained.

Once verification is completed, encrypted communications intermediate the client 12 and appliance 14 may occur. In one embodiment, client 12 may create a session key and encrypt data to be communicated (e.g., print job) using the session key. Client 12 may encrypt the session key with the device public key received in the device certificate of verification information 30a, attach the encrypted session key to the beginning of an encrypted message and communicate the encrypted message or data to appliance 14. In further communications, appliance 14 can also authenticate clients 12 and decide on a level of encryption desired.

As mentioned above, intermediaries 15 may be associated with one or more of client 12 and/or appliance 14 implementing secure communications. A client 12 may generate a session key, encrypt the session key using the public key of appliance 14, encrypt data with the session key and send the encrypted data and session key to an intermediary 15 for communication to appliance 14. For example, data sent by a client 12 may reside on the intermediary 15 (e.g., print job residing on a spooler) and be retrieved from appliance 14 (in a pull model) or be sent to appliance 14 from the intermediary 15 (in a push model). Further, intermediaries 15 may transmit verification information 30a on behalf of the sending appliance 14.

If a secondary communications channel apart from a primary communications channel having the intermediary 15 is used for communicating the verification information 30a, the client 12 may identify the verification information 30a as coming from the communications identifier of the intermediary 15 as opposed to appliance 14. In one example, clients 12 may be configured to ignore the common name of the identifier certificate 36 if the certificate comes from the communications identifier (e.g., electronic address) of the intermediary 15.

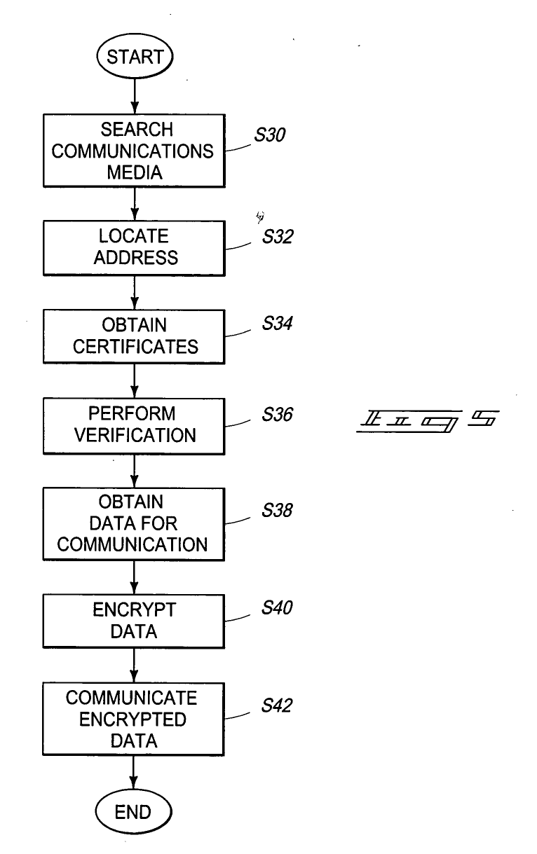

Referring to FIGS. 4-6, methods for establishing a communications channel of increased security are shown according to exemplary embodiments. Other methods including more, less or alternative steps are possible.

FIG. 4 illustrates a method for generating verification information according to one embodiment.

Initially, at a step S10, a source private and public key pair are generated by a source of an appliance.

At a step S12, a source certificate is created by signing the source public key (e.g., by a root CA in one embodiment).

At a step S14, an appliance to be configured is provided by the source. The appliance may have a unique device identifier as mentioned above.

At a step S16, the source or other entity may generate a device private and public key pair.

At a step S18, the source or other entity may create a device certificate by signing the device public key and the common name (e.g., unique device identifier) using the source private key in one embodiment.

At a step S20, the appliance is deployed wherein the appliance is associated with a communications identifier of communications media.

At a step S22, the appliance generates an identifier private and public key pair.

At a step S24, an identifier certificate of the identifier public key may be created by the appliance or a certificate authority external of the appliance. The certificate is created by signing the identifier public key and the common name (e.g., communications identifier) with the private key of the certifier (the appliance itself (e.g., device private key 35) or a certificate authority external of the appliance).

At a step S26, the verification information including the source, device and identifier certificates may be communicated externally of appliance to one or more clients.

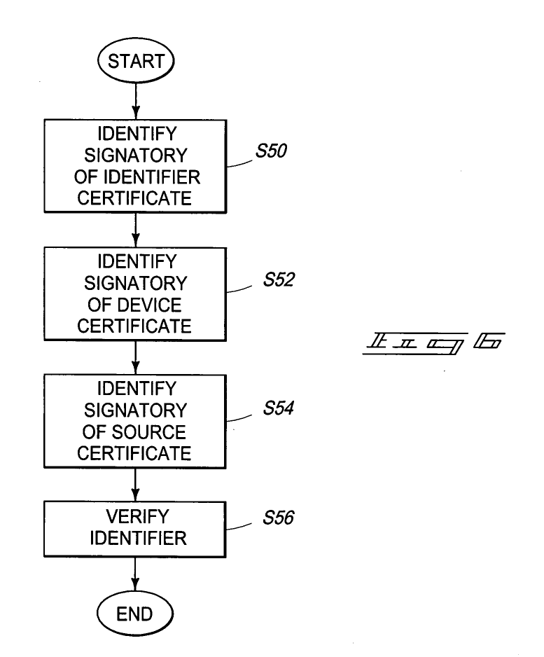

Referring to FIG. 5, an exemplary method is shown for using verification information to provide a communications channel of increased security in accordance with one embodiment.

At a step S30, a client may search an associated communications media for desired services.

At a step S32, the client may locate an electronic address or other communications identifier of an appliance providing the desired services.

At a step S34, the client may obtain certificates within verification information communicated by the appliance.

At a step S36, the client may use the verification information to verify a source of the appliance, the appliance is authentic, and/or the communications identifier associated with the appliance.

At a step S38, the client obtains data (e.g., a print job) for communication to the appliance.

At a step S40, the client encrypts the data for example using a session key in one arrangement.

At a step S42, the client communicates the encrypted data to the appliance.

Referring to FIG. 6, an exemplary method for performing verification operations of step S36 of FIG. 5 according to one embodiment is shown.

At a step S50, the client identifies the signing entity of the identifier certificate (e.g., the appliance in the above-described example).

At a step S52, the client may process the device certificate responsive to the identification of step S50. In one embodiment, the client identifies the signing entity of the device certificate (e.g., the source in the above-described example) at step S52.

At a step S54, the client may process the source certificate responsive to the identification of step S52. In one embodiment, the client identifies the signing entity of the source certificate (e.g., the source in the above-described example) at step S54. The individual appliance and source of the appliance may be verified as authentic if the signing entity of the source certificate is proper (e.g., a proper root CA). The verification information from the appliance maybe rejected if the signing entity of the source certificate is not proper.

At a step S56, the client may also verify the communications identifier of the appliance including comparing the communications identifier of the identifier certificate with the communications identifier from which the verification information was communicated in one embodiment. The communications identifier is verified if the comparison results in a match.

Exemplary embodiments facilitate security between electronic devices such as clients and appliances. The exemplary embodiments may be provided in an environment without a dedicated authorization and authentication infrastructure and which does not require manual programming of clients which need secure access. Clients may set up secure channels without knowledge of the communications identifiers of appliances. Further, appliances may be arranged to be secured by non-information technology personnel such as homeowners and spoofing or false identification of public keys are minimized since the appliance 14 can reset its session keys for individual transactions after secure communications are established. The disclosure hereof is described with reference to an exemplary embodiment implementing a secure channel intermediate a client and an appliance. Aspects described herein may be utilized to implement secure communications between any other types of electronic devices wherein security is desired.

The protection sought is not to be limited to the disclosed embodiments, which are given by way of example only, but instead is to be limited only by the scope of the appended claims.

What is claimed is:

1. An electronic device communications method comprising:
providing an appliance;
deploying the appliance comprising associating the appliance with communications media;
providing an identifier of the association of the appliance with the communications media;
generating verification information using the identifier;
communicating the verification information externally of the appliance;
using the communicated verification information, verifying at least one aspect of the deployed appliance; and
encrypting data communications intermediate a client and the appliance responsive to the verifying.

2. The method of claim 1 wherein the verifying comprises verifying the identifier.

3. The method of claim 1 wherein the verifying comprises verifying the authenticity of the appliance.

4. The method of claim 1 wherein the providing the identifier comprises providing the identifier comprising an electronic address associated with the appliance.

5. The method of claim 4 wherein the generating comprises generating a certificate comprising the electronic address.

6. The method of claim 5 wherein the verifying comprises extracting the electronic address from the certificate and comparing the extracted electronic address with an electronic address from which the verification information was communicated.

7. The method of claim 1 wherein the verifying comprises comparing an electronic address of the verification information with an electronic address from which the verification information was communicated.

8. The method of claim 1 wherein the generating the verification information comprises generating a public and private key pair, and the communicating comprises not communicating a private key of the public and private key pair.

9. The method of claim 1 wherein the generating comprises generating the verification information comprising a source certificate, and wherein the verifying comprises verifying a source of the appliance using the source certificate.

10. The method of claim 1 wherein the encrypting comprises encrypting using a session key.

11. The method of claim 1 wherein the verifying comprises verifying the authenticity of the appliance using the verification information comprising a certificate signed by a source of the appliance.

12. An appliance verification method comprising:
providing an appliance with a first private key;
deploying the appliance comprising associating the appliance with communications media configured to implement communications intermediate the appliance and a client;
generating an identifier of the association of the appliance with the communications media;
generating a key pair comprising a public key and a second private key after the deploying; and
providing a certificate comprising signing the public key and the identifier using the first private key.

13. The method of claim 12 further comprising communicating the certificate to the client.

14. The method of claim 13 wherein the communicating comprises communicating using the communications media.

15. The method of claim 13 wherein the communicating comprises communicating using a communications channel other than a communications channel used to communicate encrypted data.

16. The method of claim 13 wherein the communicating comprises communicating using an intermediary.

17. The method of claim 13 further comprising:
extracting the identifier using the client; and
verifying the identifier comprising comparing the extracted identifier with an electronic address from which the certificate was communicated.

18. The method of claim 12 further comprising verifying a source of the appliance using the client.

19. An appliance programming method comprising:
providing an appliance for use with a client;
first configuring the appliance to initiate formation of an identifier certificate after deployment of the appliance including association of the appliance with a communications medium, wherein the identifier certificate is usable to verify at least one aspect of the deployed appliance; and
second configuring the appliance to implement encrypted communications with the client after the verification of the at least one aspect of the deployed appliance.

20. The method of claim 19 wherein the identifier certificate is usable to verify the association of the appliance with the communications media.

21. The method of claim 19 wherein the first configuring comprises configuring the appliance to form the identifier certificate using an electronic address associated with the appliance after the deployment.

22. The method of claim 19 wherein the first configuring comprises configuring the appliance to use a private key to form the identifier certificate.

23. The method of claim 19 further comprising third configuring the appliance to comprise a source certificate usable to verify a source of the appliance.

24. The method of claim 19 further comprising third configuring the appliance to comprise a device certificate usable to verify an identity of the appliance.

25. The method of claim 19 further comprising providing the appliance with a first private key prior to deployment of the appliance, and wherein the first configuring comprises configuring the appliance to generate a key pair comprising a public key and a second private key and to sign the public key and an identifier of the association using the first private key to generate the identifier certificate.

26. An appliance comprising:
a communications interface configured to implement communications with respect to communications media coupled with a client; and
processing circuitry coupled with the communications interface and wherein the processing circuitry is configured to access an electronic address after the appliance is associated with the electronic address to implement communications with respect to the communications medium, to initiate generation of an identifier certificate using the electronic address, and to initiate communication of the identifier certificate externally of the appliance to enable verification of the electronic address of the appliance to enable communications via the communications medium intermediate the client and the appliance.

27. The appliance of claim 26 wherein the processing circuitry is configured to generate the identifier certificate using the electronic address comprising a common name of the identifier certificate.

28. The appliance of claim 26 further comprising storage circuitry configured to store a first private key, and wherein the processing circuitry is configured to generate a second private key and a public key and to sign the public key and the electronic address using the first private key to generate to the identifier certificate.

29. The appliance of claim 28 wherein the storage circuitry is configured to store the first private key prior to association of the appliance with the communications media.

30. The appliance of claim 28 wherein the storage circuitry is configured to store a device certificate comprising the first private key.

31. The appliance of claim 26 wherein the processing circuitry is configured to implement encrypted communications with respect to the client after the communication of the identifier certificate.

32. An article of manufacture comprising:
media configured to store programming configured to cause processing circuitry to:
access an identifier of an association of an appliance with communications media;
initiate formation of an identifier certificate using the identifier of the association, wherein the identifier certificate is usable by a client to verify the association of the appliance with the communications media;
control communication of the identifier certificate to the client; and
implement encrypted communications with the client after the communication of the identifier certificate to the client.

33. The article of claim 32 wherein the processing circuitry comprises processing circuitry of the appliance.

34. The article of claim 33 wherein the appliance is provided with a first private key, and the programming is configured to cause the processing circuitry to generate a second private key and a public key and to sign the public key and the identifier using the first private key to generate the identifier certificate.

35. The article of claim 33 wherein the programming is configured to cause the processing circuitry to access the identifier after deployment of the appliance with respect to the communications media.

36. The article of claim 33 wherein the appliance is provided with a source certificate usable to verify a source of the appliance, and wherein the programming is further configured to cause the processing circuitry to control communication of the source certificate to the client.

37. The article of claim 32 wherein the programming is configured to cause the processing circuitry to implement the encrypted communications using a session key.

38. A client electronic device comprising:
means for communicating with respect to a communications media;
means for accessing verification information corresponding to an appliance from the communications media;
means for accessing an electronic address of the appliance;
means for verifying the electronic address using the verification information;
means for encrypting data for communication to the appliance responsive to verification of the electronic address; and
wherein the means for communicating comprises means for communicating the encrypted data.

39. The device of claim 38 wherein the means for verifying comprises means for comparing the electronic address with an electronic address from which the verification information was communicated.

40. The device of claim 38 further comprising means for verifying a source of the appliance using the verification information.

41. The device of claim 38 wherein the means for encrypting comprises means for encrypting using a session key.
